(19) United States
(12) Patent Application Publication
(10) Pub. No.: US 2022/0405442 A1
(43) Pub. Date: Dec. 22, 2022

(54) Design Optimization Guided by Discrete Geometrical Pattern Library

(71) Applicant: Dassault Systemes Simulia Corp., Johnston, RI (US)

(72) Inventors: Martin-Pierre Hugo Schmidt, Velizy-Villacoublay (FR); Claus Bech Wittendorf Pedersen, Hamburg (DE); Tanguy Theo Navez, Velizy-Villacoublay (FR)

(21) Appl. No.: 17/748,272

(22) Filed: May 19, 2022

Related U.S. Application Data
(60) Provisional application No. 63/213,277, filed on Jun. 22, 2021.

(51) Int. Cl. G06F 30/23; G06F 30/10

(52) U.S. Cl. CPC G06F 30/23; G06F 30/10; G06F 2111/04

(57) ABSTRACT

A discrete geometrical pattern library guides a method for design optimization of a finite element model in a computer aided design (CAD) environment. Boundary conditions are applied to the finite element model, design variables for the bounded finite element model are initialized, and an objective function for the finite element model is evaluated. A gradient of the objective function is evaluated with respect to the design variables, an appearance constraint function is evaluated for the finite element model, and a gradient of the appearance constraint function is evaluated with respect to the design variables. The design variables are updated using a mathematical programming, and a convergence in the design optimization is detected, producing a converged design optimization of the finite element model is produced.

### CROSS-REFERENCE TO RELATED APPLICATIONS

This application claims the benefit of U.S. Provisional Patent Application serial number 63/213,277, filed Jun. 22, 2021, entitled “Design Optimization Guided by Discrete Geometrical Pattern Library” which is incorporated by reference herein in its entirety.

### FIELD OF THE INVENTION

The present invention relates to computer aided design, and more particularly, is related to automated structural optimization (topology optimization) of a modeled object.

### BACKGROUND OF THE INVENTION

In recent years, the industrial design processes are transforming from trial and error to modern design processes that include simulations and automated sensitivity based non-parametric optimization for the early design processes. Because the previously obtained designs may be difficult to manufacture and/or very costly to manufacture, the industrial user typically prefers to guide the design in a certain direction without significant loss in performance on other key performance indicators. Additionally, the previously obtained designs sometimes lacked certain desired visual effects, for example for brand and design recognition. Today no single approach exists for industrial non-parametric optimization that simultaneously addresses these optimization and/or design challenges.

There are many different approaches for non-parametric optimization methods (topology, shape, bead, and sizing) enforcing geometrical properties directly or indirectly for obtaining various visual looks and effects for the optimized designs or/and fulfilling various manufacturing requirements given in the geometrical space. Several approaches have been utilized to enforce properties on the designs and these enforcements are mainly mechanical.

In previous design approaches, designs are constrained to have a certain stiffness and mass, and then an objective function is set up as an appearance control measurement for controlling the shape of the design compared to a single predefined pattern. However, this results in the resulting design being constrained according to the one predefined pattern.

Some approaches apply local volume constraint approaches enforcing geometrically porous structures for example for imitating lattice like structures. Other approaches employ topology optimization techniques with geometric variable components. Often these methods are called Moving Morphable Components (MMC) and applications for isotropic material optimization and orthotropic, fiber-reinforced materials. These methods can only mimic one geometric primitive type (e.g., a beam primitive or a plate primitive) per optimization. Secondly, these methods have variable geometric design variable components (e.g., beam length as design variables continuously varying from 4 m to 10 m).

Other design approaches utilize discrete non-parametric optimization of laminated composites using material interpolation schemes, for example, using penalized continuous material interpolations of the discrete constitutive material models for mapping between the different composite types. Here, continuous optimization is applied for optimizing discretely between the various laminates. This approach interpolates between different materials. This effectively forces the user to choose from one of the several composite types, such that the resulting design strictly matches the mechanical properties of the selected materials.

There have also been attempts at direct discrete topology optimization in topology optimization directly using mixed-integer programming. However, the direct discrete topology optimization approaches based upon mixed-integer programming have not proven scalable in runtime. Therefore, these approaches can only address small academic models and has shown not practical for large 3D academic models or industrial models.

Another approach applies multi-scale for topology optimization that map and guide the structural mechanical properties between multi-scales, e.g., between macrostructure and microstructure. Yet another approach applies design variable parametrization using filter techniques and projection methods of the design variables. For example, for enforcing length scales for manufacturing, AM manufacturing availability and classical manufacturing availability. There is a need in the industry to address shortcomings of the abovementioned approaches.

### SUMMARY OF THE INVENTION

Embodiments of the present invention provide a design optimization method guided by a discrete geometrical pattern library. Briefly described, the present invention is directed to a method for design optimization of a finite element model in a computer aided design (CAD) environment guided by a discrete geometrical pattern library. Boundary conditions are applied to the finite element model, design variables for the bounded finite element model are initialized, and an objective function for the finite element model is evaluated. A gradient of the objective function is evaluated with respect to the design variables, an appearance constraint function is evaluated for the finite element model, and a gradient of the appearance constraint function is evaluated with respect to the design variables. The design variables are updated using a mathematical programming, and a convergence in the design optimization is detected, producing a converged design optimization of the finite element model is produced.

Another aspect of the present invention is directed to evaluating a secondary constraint for the finite element model, evaluating the secondary constraint with respect to the design variables, and evaluating a secondary objective.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principals of the invention.

FIG. 1 is a flowchart illustrating an exemplary embodiment of a method for design optimization guided by a discrete geometrical pattern library.

FIG. 2 is an appearance constraint flowchart expanding upon block 150 of FIG. 1.

FIG. 3A is a schematic diagram depicting a model specification for a Topology Optimization scenario.

FIG. 3B is a schematic diagram depicting evolving design during the iterative optimization process.

FIG. 4A is a schematic diagram showing an initial stage of a process computing a mapping from each point in a design space to its best matching region in the pattern library.

FIG. 4B is a schematic diagram showing a switch search stage of the process of FIG. 4A.

FIG. 4C is a schematic diagram showing a walk search stage of the process of FIG. 4A.

FIG. 4D is a schematic diagram showing a propagation stage of the process of FIG. 4A.

FIG. 5A is a schematic diagram showing a structural finite element model and applied discrete pattern library.

FIG. 5B is a schematic diagram showing an obtained 2D optimized design of the finite element model of FIG. 5A without an appearance constraint.

FIG. 5C is a schematic diagram showing an obtained 2D optimized design of the finite element model of FIG. 5A with an appearance constraint of 0.16.

FIG. 6 is a series of three graphs plotting an exemplary optimization iteration history: an objective function, followed by two constraints.

FIG. 7 is a graph plotting compliance against appearance constraint value as an external parameter guiding the geometrical layout of the optimized design.

FIG. 8 shows a 3D example optimized design using the finite element model of FIGS. 5A-C.

FIG. 9A is a schematic diagram showing a beam bending with a load at the top and fixed regions at the bottom corners.

FIG. 9B is a schematic diagram showing a bridge with five loads distributed at the top and having fixed regions at the bottom corners.

FIG. 10 is an illustration of the optimized fiber orientations for a beam design exhibiting issues with non-convexity (top) and an improved beam design where the fiber orientations correctly follow curved paths (bottom).

FIG. 11A is an illustration of exemplary fiber orientations for a subcomponent beam design exhibiting issues with non-convexity.

FIG. 11B is an illustration of an improvement of the beam design of FIG. 11A obtained by guiding the optimization using a pattern library.

FIG. 11C is an illustration of patterns in a pattern library of preferred fiber orientations relative to the loading directions of the structural subcomponent members of FIG. 11B.

FIG. 12A is an illustration of an exemplary the fiber orientation in a bridge design exhibiting a vector field singularity in the design variable orientations due to a 3-way attachment point of three subcomponents.

FIG. 12B is an illustration of an improvement over the bridge design of FIG. 12A where the vector field singularity in the design variable orientations is resolved by avoiding a 3-way crossing of the material orientations.

FIG. 13 is a schematic diagram illustrating an example of a system for executing functionality of the present invention.

### DETAILED DESCRIPTION

The following definitions are useful for interpreting terms applied to features of the embodiments disclosed herein, and are meant only to define elements within the disclosure.

As used within this disclosure, an “objective function” refers to an expression (function) to be minimized or maximized for a given application. For example, for a structural model, an objective function determining a rigidity or compliance of the modeled object may be used to determine a maximum/minimum rigidity or compliance value.

As used within this disclosure, “the design” and “the structure” may be used interchangeably to refer to the form and features of a modeled object.

As used within this disclosure, “design variables” refer to a set of parameters describing an object being modeled (“the modeled object”). The design variables for the modeled object are parameters having values which are modified by an optimization process in order to maximize/minimize the objective function. A common example is to have design variables representing the relative density of material at each point in space, thus a 3D object can be seen as a set of relative density values between 0 and 1 where 0 represents void and 1 represent solid material.

As used within this disclosure, a “pattern library” refers to a collection of patterns. Each pattern describes a set of desirable values for the design variables. Thus, the pattern library can be thought of as a collection of examples of shapes and behaviors to be incorporated in the final design. If the design variables are the density of material at each point in space, then a pattern may be an example of density distribution describing an aesthetic shape, a brand logo, a specifically tailored microstructure, among others. The patterns in the library do not need to be ordered or have the same dimensions.

As used within this disclosure, “Multiphysics” refers to coupled processes or systems involving more than one simultaneously occurring physical field and the approaches regarding these processes and systems.

As used within this disclosure, “boundary conditions” generally refer to locations in a model where the design is fixed with regard to deformations (“being clamped”).

As used within this disclosure, “voxels” refers to a set of uniform three dimensional discrete elements that may be used to approximate the mass of a three dimensionally modelled object. While as used herein “voxels” generally refers to cube shaped voxels, discrete elements of different shapes (e.g., quadrilateral and triangle elements in 2D and, tetrahedron, hexahedron, wedge, and pyramid elements (“prisms”) in 3D) may be used in some embodiments. For example, a finite element geometric model may be apportioned into a plurality of cube shaped voxels, and a density value is adjusted for each voxel according to an optimization process.

As used within this disclosure, a “mesh” generally refers to a “finite element mesh”, for example, a set of volume element (such as cubes, tetrahedra, or prisms, among others) subdividing the 3D model. A finite element mesh is used to evaluate physical properties (e.g., stiffness) via finite element analysis.

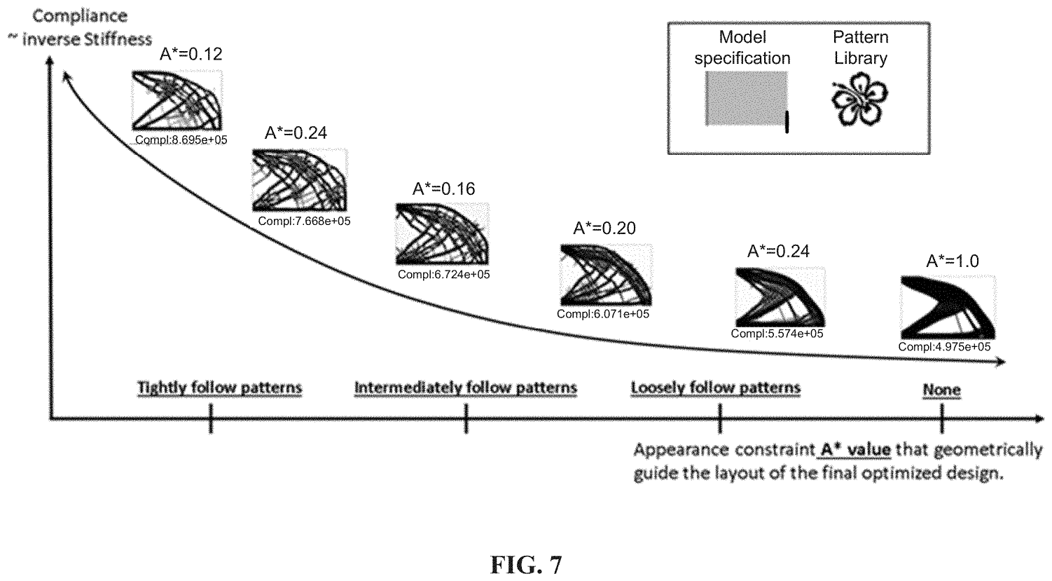

As used within this disclosure, the “total allowable appearance fraction” refers to a parameter having a value indicating the appearance (in the range [0;1]) of a model. Functionally, this parameter servers a simple user-friendly slider to adjust the tolerance of the appearance constraint, i.e., how loosely the design will resemble to the pattern library. This is illustrated in FIG. 7. By setting the total allowable appearance fraction value to 1, the appearance constraint is completely loose, i.e., it has literally no effect of the final converged design. By setting this value to 0, the appearance constraint basically has no tolerance, i.e., every region if the design must perfectly match a region in the pattern library. In a typical example, the user/designer may experimentally adjust the total allowable appearance fraction to achieve a desired compromise between mechanical efficiency and aesthetics.

As used within this disclosure, a “secondary constraint” refers to any supplementary constraint imposed upon a model/pattern, where “secondary” is not intended to represent either an order of implementation or a level of priority.

Reference will now be made in detail to embodiments of the present invention, examples of which are illustrated in the accompanying drawings. Wherever possible, the same reference numbers are used in the drawings and the description to refer to the same or like parts.

Embodiments of the present invention described herein are directed to an extension of the classic topology optimization. The embodiments include a general constraint, referred-to as the “appearance constraint.” The appearance constraint is added to the numerical optimization workflow and allows the user to provide a collection of patterns forming a library. An appearance measurement value is evaluated by formulating a distance metric between the current geometrical state of the design variables and the patterns of the library. Moreover, by making the distance metric differentiable, the gradients of the appearance value may be calculated with respect to the design variables for the optimization problem. Finally, by constraining the appearance value, the numerical optimization is then enforced to produce designs exhibiting geometrical properties from the discrete patterns defined in the library.

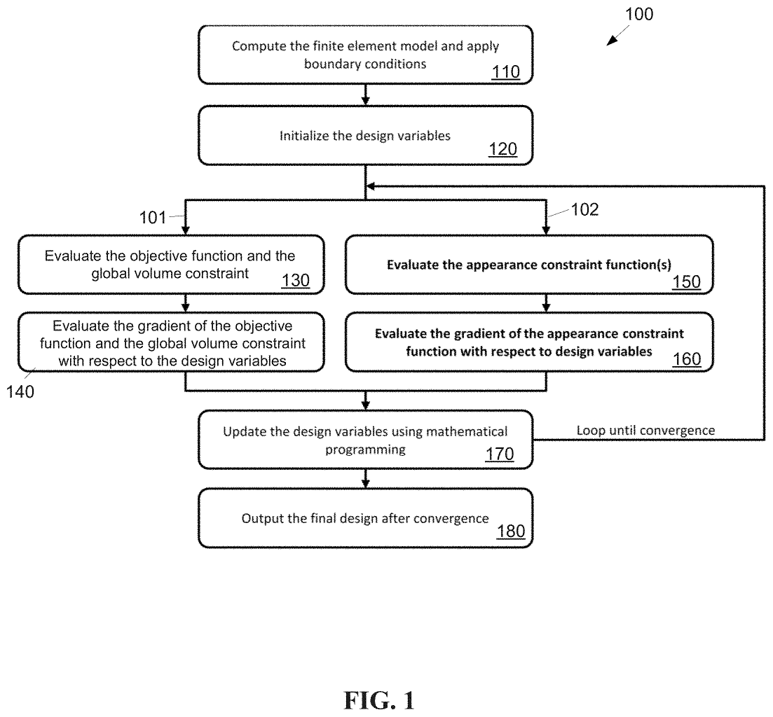

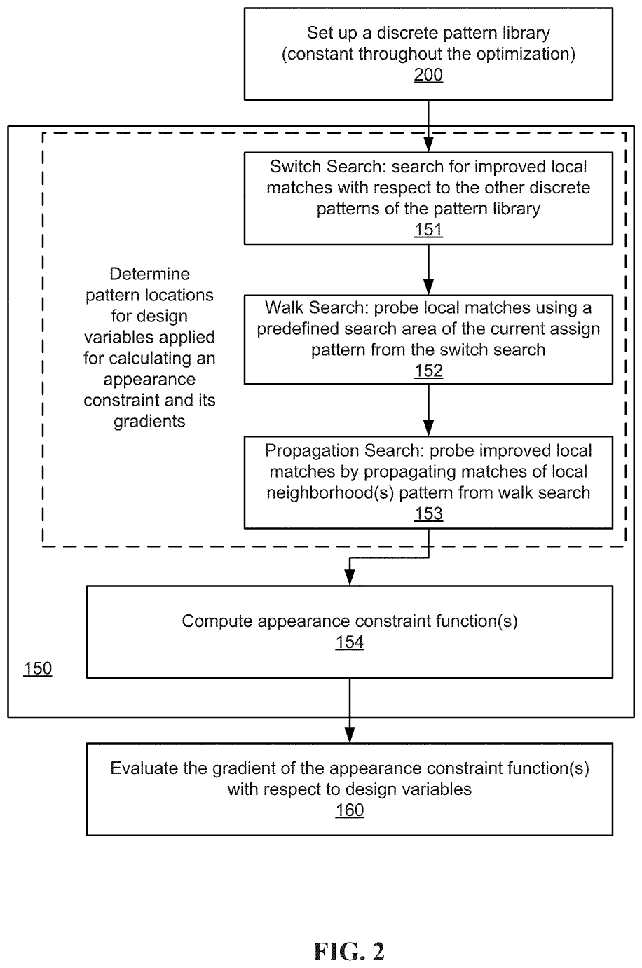

FIG. 1 is a flowchart illustrating an exemplary embodiment of a method 100 for design optimization guided by a discrete geometrical pattern library. The embodiments disclosed herein are best described in the context of a typical Topology Optimization workflow as known in the state of art and most widely used by academic and industrial applications in the field of structural designing and optimization. This context generally refers to FIG. 1 blocks 110-140 and 170, 180, which indicate the flow for solving a general numerical optimization problem. FIG. 1 blocks 150 and 160 are directed to appearance constraint guided by a discrete pattern library in the context of Topology Optimization allowing more external user control over the geometrical layout of the optimized structures. The embodiments directed to FIG. 1 blocks 150 and 160 are shown in more detail by FIG. 2 and described after a description of the context.

Returning to FIG. 1, it should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

A finite element model is computed, and boundary conditions are applied as shown by block 110. Design variables for the bounded finite element model are initialized, as shown by block 120. The method 100 is thereafter divided into a first path 101 shown by blocks 130 and 140, and a parallel second path 102 shown by blocks 150 and 160. In the first path an objective function and a global volume constraint for the finite element model is evaluated, as shown by block 130. A gradient of the objective function and a global volume constraint is evaluated with respect to the design variables, as shown by block 140.

In the second path 102, an appearance constraint function is evaluated, as shown by block 150. A gradient of the appearance constraint function is evaluated with respect to the design variables, as shown by block 160. Block 170 receives the output of the first path 101 and the second path 102. The design variables are updated using mathematical programming, as shown by block 170. If the optimization process does not converge, control returns to blocks 130 and 150. If the optimization process converges, the process 100 produces a final design of the finite element model, as shown by block 180. FIG. 2 presents a high level flow of the present embodiments, which are described in further detail below.

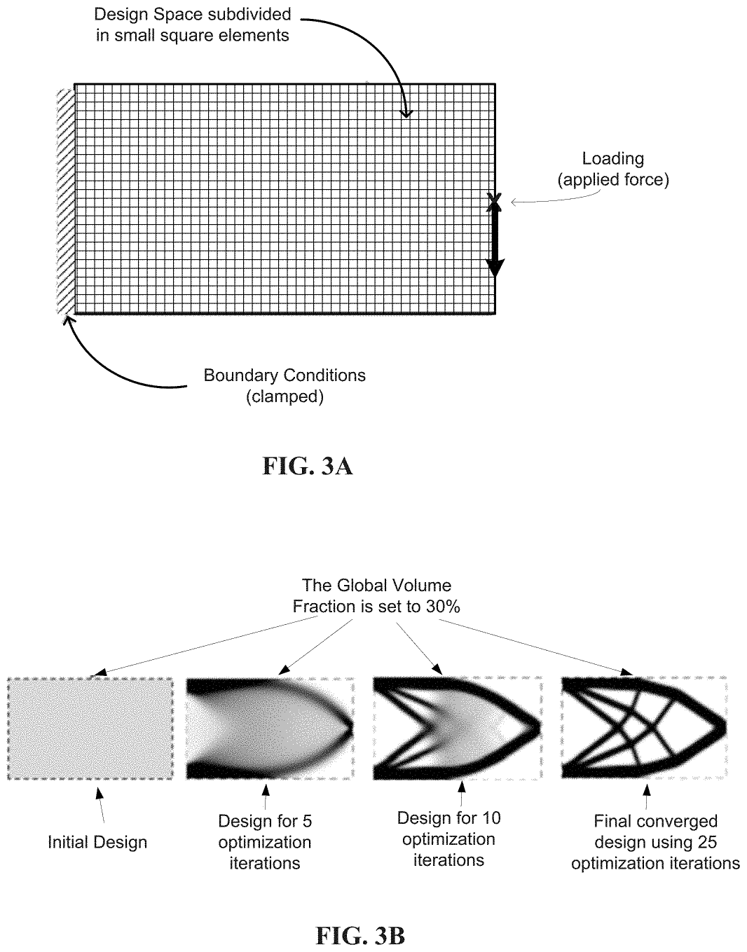

As shown by FIG. 3A, the general Topology Optimization workflow requires as input a design space, a set of load-cases (the forces that will be applied on the design) and boundary conditions (locations where the design is fixed in the deformations, a.k.a. “being clamped”). Additional parameters may also be defined, for example, an outer shell profile that must be kept, the mechanical constitutive properties of the chosen materials, the target mass, the maximum allowed deformation, among others. In general, the design workflow does not require an initial geometry beyond a design space definition since the goal of topology optimization is to generate an optimized design for an empty canvas, namely the design space.

The output of the workflow 100 is a geometrical description of the optimized design, as shown by FIG. 1 block 180, which complies with the modeling input and the optimization input specifications. FIG. 3A shows an example of one such design over the optimization iteration process.

A typical topology optimization workflow follows the eight steps of the flowchart of FIG. 1. As per block 110, the finite element model is computed, and boundary conditions are applied. A discretization of the design space is created, as shown in FIG. 3A. This discretization involves subdividing the space into small simple connected elements, for example tetrahedrons, hexahedrons, and the like. These small elements may eventually serve as both a finite element mesh for a simulation of the model and for containing the design variables for the optimization. Here, the forces and clamped boundary conditions for a given input specification are applied to nodes of the finite element mesh. FIG. 3A shows a mesh where the design space is subdivided into regular square elements. The nodes on the left side are clamped and a downward force is applied on the middle right hand side of the design space.

Design variables for the bounded finite element model are initialized, as shown by block 120. Each element has a given relative density value defining whether it is empty or full of material, for example, respectively defined by the values “0” and “1”. In order to make the optimization problem continuous, each element i in the design space Ω is given a continuous property 0≤ρ(i)≤1 called relative density. Since the interpretation of elements with intermediate densities can be ambiguous, a penalization exponent is used to force intermediate elemental densities to be globally less efficient for the structural behavior than elements with the lower and upper bound of 0 or 1, respectively. This has the effect of driving the optimizer to produce final designs with few intermediate densities, while still maintaining the continuous formulation as shown in FIG. 3B.

An objective function for the finite element model is evaluated, as shown by block 130. A complete defined finite element model is defined upon initializing design variables for the bounded finite element model are initialized. The finite element model is meshed and attached with forces and clamped boundary conditions, where each element has a relative density value. Based upon the finite element model, a global stiffness matrix is assembled and solved for the nodal displacements of the structural equilibrium. This effectively computes the deformation of the structure in its current state for the applied forces and boundary conditions. The most often used objective function in topology optimization is the compliance of the structure. The compliance topology optimization is the inverse of the stiffness and thus encapsulates an amount of deformation of the structure considering specified load scenarios and boundary conditions, expressed by Eq. 1:

J(ρ)=f^{T}u (Eq. 1)

where f and u are the nodal force and nodal displacement vectors, respectively.

Assuming a linear structural model, the vectors f and u are connected by the global stiffness matrix K from the state equilibrium equation:

K=fu (Eq. 2)

When the optimization process minimizes the compliance, it corresponds to maximize the stiffness of the design for a given mass.

A global volume constraint function for the finite element model is evaluated, as shown by block 130. The global volume constraint function measures a fractional portion of the volume of the design space occupied with material. Thereby, the global volume constraint function defines the maximum allowed material volume to be used and therefore, is equal to the maximum mass of material for the design. The global volume constraint function is expressed as follows:

$${G}_{t o t} ( ρ ) = \frac{1}{{G}_{t o t}^{*} \vert Ω \vert} {\sum }_{i ∈ Ω} ( ρ ( i ) {v}_{i} ) - 1 \leq 0 \qquad ( Eq . 3 )$$

where vᵢ is the volume of an element i, |Ω| is the number of elements and Gₜₒₜ^{*} is the total allowable volume fraction. Consequently, the optimizer determines an optimal distribution of this mass in the design space maximizing the stiffness. FIG. 3B shows intermediate designs in the optimization workflow where the Global Volume Fraction is the same but the distribution of material changes during the optimization iteration in process.

A gradient of the objective function is evaluated with respect to the design variables, as shown by block 140. Due to the large number of design variables in the process, the optimization is generally solved using a gradient-based optimization method. Therefore, derivatives of the objective function are also computed with respect to each design variable. This indicates how the relative density of each element should be changed to improve the compliance and fulfilling the constraints. For the compliance, evaluation of the gradient of the objective function may be performed using the Adjoint Sensitivity Analysis, which is considered a standard calculation. Once calculated, these derivatives may be smoothed through a filtering process to improve numerical stability, reduce erroneous checkerboard patterns, and introduce a well defined length scale into the optimization.

A gradient of the global volume constraint function is evaluated with respect to the design variables, as shown by block 140. If the elements are equal in size, the derivatives are constant for each element and therefore, trivial to compute, as per a standard procedure in topology optimization.

An appearance constraint function is evaluated, as shown by block 150 and is described in detail below regarding FIG. 2.

The gradient of the appearance constraint function is evaluated with respect to the design variables, as shown by block 160. For the exemplary embodiments, the gradient of the appearance constraint is computed, which is described in detail below regarding FIG. 2.

Block 170 receives the output of the first path 101 and the second path 102. The design variables are updated using mathematical programming, as shown by block 170. When the values of the objective function and the constraints are known as well as their derivatives, a gradient-based mathematical programming may be used to modify the relative density of each element to improve the structural compliance without violating the specified constraints. For example, a general mathematical programming approach often used in topology optimization is the Method of Moving Asymptotes (MMA). While the exemplary embodiments employ the MMA approach because it can handle multiple nonlinear constraints, other mathematical programming approaches may be used. Once the relative density value of each element is modified by the mathematical programming, if the given modified design in the optimization process has not yet converged, control returns to blocks 130 and 150.

Once the optimization process has converged, the process 100 produces a final design of the finite element model, as shown by block 180. A convergence criterion can be set in various ways, but common examples include a fixed number of iterations, a threshold on the magnitude of change for the design variables, or a threshold on the magnitude of change for the objective function value. Upon optimization convergence a finalized design in the Design Space results where each element has an optimized relative density value. Through a simple thresholding process, the geometry defined by the collection of elements is extracted whose relative density value is above a certain threshold, for example, a density of 0.5. The topology optimization workflow 100 produces an optimized design geometry. A typical optimization formulation for FIG. 1 may be summarized as:

$$argmin J ( ρ ) = {f}^{T} u s . t \{ \begin{matrix}K ( ρ ) u = {f}^{T} u \\ 0 < ρ ( x ) < 1 , ∀ x ∈ Ω \\ {G}_{t o t} ( ρ ) = \frac{1}{{G}_{t o t}^{*} \vert Ω \vert} {\sum }_{i ∈ Ω} ( ρ ( i ) {v}_{i} ) - 1 \leq 0 \\ Other constraints …\end{matrix} \qquad ( Eq . 4 )$$

FIG. 2 is an appearance constraint flowchart expanding upon block 150 of FIG. 1. FIG. 2 shows the workflow for setting up a user defined discrete pattern library (block 200), matching the design variables to the pattern library for each optimization iteration (blocks 151-153) and calculating the appearance constraint based up the previously determined machining as well as the derivatives of the appearance constraint (blocks 154, 160). The process shown in FIG. 2 is described in further detail below.

The exemplary embodiments introduce the use of an appearance constraint function Aₜₒₜ(ρ) consisting of a measure for the local similarity of the design to a pattern library. The appearance constraint relies on a matching patch assignment step (described below) followed by the computation of the appearance value (block 154). Then the appearance constraint gradients are computed with respect to the design variables (block 160).

During the matching patch assignment, a mapping is computed from each point in the design space to its best matching region in the pattern library. This matching may be done with a so-called brute-force approach which explores the full combinatorial space to find the optimal match for each patch. However, the computational cost of such an approach may be too high for any non-trivial case. Therefore, it is preferred to implement a scheme capable of approximating an optimal match by leveraging locality in the matching process. One such scheme candidate is PatchMatch, described in the following article: https://gfx.cs.princeton.edu/pubs/Barnes_2009_PAR/. The PatchMatch is based on the propagation of matches to surrounding areas for imagery coherence and a few random samplings to avoid being stuck in a local minimum. For example, a shape of patches used for comparison may be simple cubes.

While FIG. 2 describes adding an appearance constraint to the optimization process, in addition the optimization may include the steps of evaluating a secondary constraint for the finite element model, evaluating the secondary constraint with respect to the design variables, and evaluating one or more additional objectives. For example, an additional constraint may include a stress constraint, a modal eigenfrequency as an objective to maximized, a displacement constraint, and a force constraint, among others. Further, enhancing physical properties for other design responses (DRESPs) may be applied in the optimization setup.

More specifically, under the exemplary embodiment the optimization problems may have one objective function and [0;N] constraint functions. Functions may be freely added or swapped in this formulation depending on the physical and geometrical properties as per the design. It is important to evaluate the functions and their derivatives with respect to the design variables at each optimization iteration.

For example, one implementation under the present embodiments may:
minimize mass subject to a displacement constraint;
minimize peak stress subject to a mass constraint and an appearance constraint;
maximize heat flux subject to an appearance constraint; and
minimize compliance subject to an appearance constraint, an eigenfrequency constraint, a mass constraint, a temperature constraint, a force constraint, a displacement constraint and an overhang constraint, or another structural or Multiphysics constraint, among others.

While the appearance function (and its derivative) is central to the embodiments, this appearance function is compatible with many other objective and constraint functions as listed above.

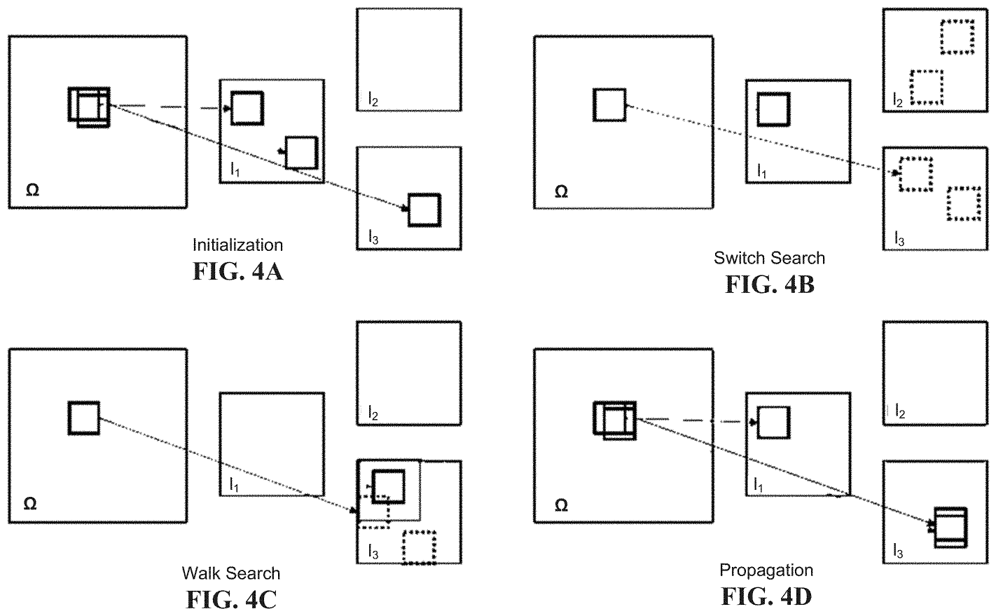

An example of the typical steps for such an algorithm using rectangular patches in two dimensions is shown in FIGS. 4A-D. Best matches between the design space Ω and the pattern library inputs l1-l3 are initialized at random during the initialization, as shown in FIG. 4A. At the switch search phase, shown by FIG. 4B, improvements for a first patch (shown in red) are randomly searched for in other inputs from the pattern library. A better assignment for the first patch is searched for inside a concentric neighborhood in its current input during the walk search phase, as shown in FIG. 4C. Finally, during a propagation shown in FIG. 4D, better patch assignments for a second patch (shown in blue) and a third patch (shown in orange) are checked and the best match is propagated.

The appearance constraint and its derivatives are evaluated using the result of the matching assignment. A typical formulation of the appearance constraint is:

$${A}_{t o t} = \frac{{\sum }_{i ∈ Ω} {D}_{i}}{{A}_{t o t}^{⋆} \times \vert Ω \vert} - 1 \leq 0 \qquad ( Eq . 5 )$$

with Dᵢ the distance between the neighbors of an element i and its matching patch, |Ω| the number of elements and Aₜₒₜ^{*} the total allowable appearance fraction.

Several mathematical expressions can be used for Dᵢ, provided that they are differentiable and normalized between 0 and 1. An example that numerically works well is the following distance expression:

$${D}_{i} = \frac{{ρ}_{i} {\sum }_{j ∈ {ω}_{i}} {( {ρ}_{j} - {α}_{i , j} )}^{2}}{2 {\sum }_{j ∈ {ω}_{i}} {( 0.5 - {α}_{i , j} )}^{2}} \qquad ( Eq . 6 )$$

where α_{i,j} are constant densities in the matching patch of the pattern library.

In Eq. 6, the sum of the squared difference of relative densities between corresponding elements in the matching patches is used to quantify the distance between the two patches and thereby, how well they match.

The 2 Σ_{j∈ω}_{ᵢ}(0.5−α_{i,j})² normalization factor normalizes the values to be between 0 and 1. Compared to a normalization by the worst possible distance, which would be the simple number of elements in a patch, then the present normalization factor yields an improved range of possible appearance values. Therefore, the present normalization factor allows the user an improved control of the constraint value Aₜₒₜ^{*} and an understanding of how variations in this constraint value Aₜₒₜ^{*} influence the appearance of the patterns from the library in the optimized design. Multiplication by the density ρᵢ of the central patch allows the optimizer to match with full void patches. It is possible to remove this last term, for example by including an empty pattern in the pattern library.

Appearance constraint derivatives for each element are obtained via the chain rule:

$$\frac{δ {A}_{t o t}}{δ {ρ}_{j}} = {\sum }_{i \vert j ∈ {ω}_{i}} \frac{δ {A}_{t o t}}{δ {D}_{i}} \frac{δ {D}_{i}}{{δρ}_{j}} = {\sum }_{i \vert j ∈ {ω}_{i}} \frac{1}{{G}_{app}^{⋆} \times \vert Ω \vert} \times \{ \begin{matrix}( \frac{{D}_{i}}{{ρ}_{i}} + \frac{{ρ}_{i} \times 2 ( {ρ}_{j} - {α}_{i , j} )}{2 {\sum }_{j ∈ {ω}_{i}} {( 0.5 - {α}_{i , j} )}^{2}} ) , if i = j \\ ( \frac{{ρ}_{i} \times 2 ( {ρ}_{j} - {α}_{i , j} )}{2 {\sum }_{j ∈ {ω}_{i}} {( 0.5 - {α}_{i , j} )}^{2}} ) , if i \neq j\end{matrix} \qquad ( Eq . 7 )$$

Once the appearance constraint gradient has been derived, the formulation for the optimization problem using the appearance constraint yields:

$$argmin J ( ρ ) = {f}^{T} u \qquad ( Eq . 8 )$$

$$s . t \{ \begin{matrix}K ( ρ ) u = f \\ 0 < ρ ( x ) < 1 , ∀ x ∈ Ω \\ {G}_{t o t} ( ρ ) = \frac{1}{{G}_{t o t}^{*} \vert Ω \vert} {\sum }_{i ∈ Ω} ( ρ ( i ) {v}_{i} ) - 1 \leq 0 \\ {A}_{t o t} = \frac{{\sum }_{i ∈ Ω} {D}_{i}}{{A}_{t o t}^{⋆} \times \vert Ω \vert} - 1 \leq 0\end{matrix} \qquad ( Eq . 9 )$$

The mathematical optimization determines the optimal distribution of the mass Gₜₒₜ^{*} in the design space maximizing the stiffness and fulfilling the fraction for the appearance Aₜₒₜ^{*} constraint provided by the user.

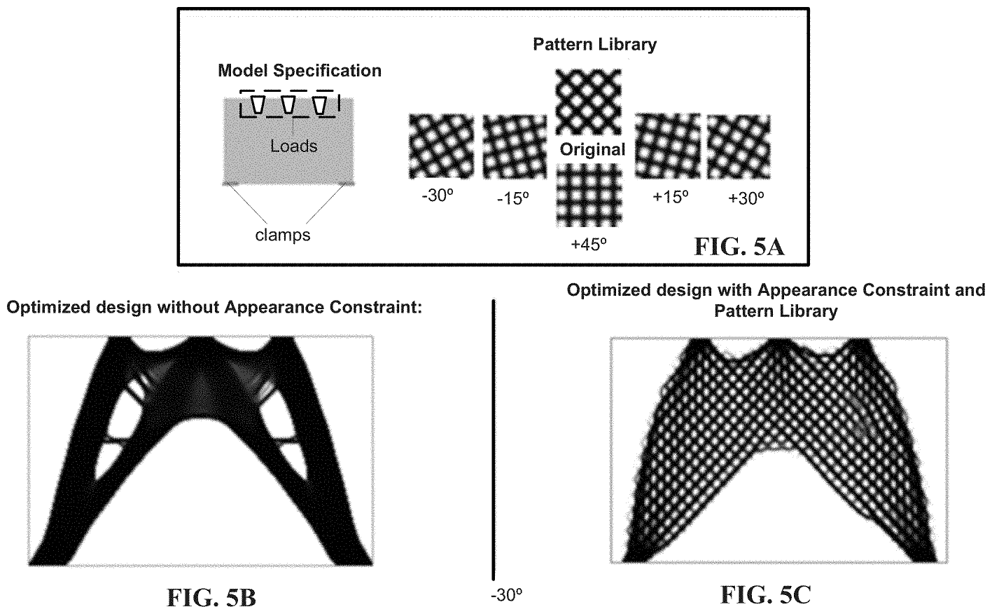

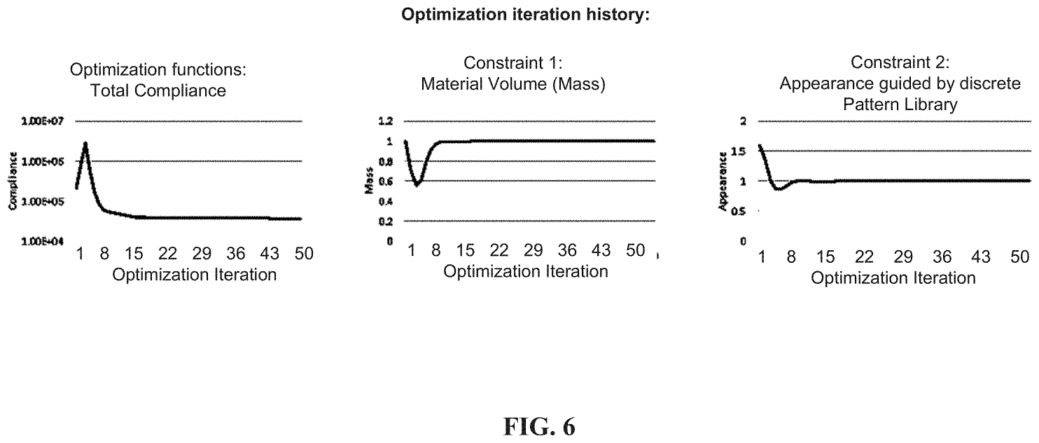

A 2D example obtained with the previously presented expression Dᵢ is shown in FIG. 5A where the loads and clamps are indicated. FIG. 5B shows an example of an application without using a library of oriented grids and the corresponding optimization iterative history without an appearance constraint. FIG. 5C shows an example of an application using a library of oriented grids to generate an oriented structure and the corresponding optimization iterative history with an appearance constraint, in this example, an appearance constraint of 0.16. FIG. 6 shows an optimization iteration history using the workflow in FIGS: 5A-C for compliance minimization, mass constraint and the uniquely suggested appearance constraint geometrical guiding the optimized design according to predefined patterns.

FIG. 7 shows an example where the user defined appearance constraint value is an external parameter guiding the optimization design to follow the patterns loosely, intermediately, or tightly from the predefined pattern library and thereby, geometrically guide the layout of the final optimized design. Note, that the material volume constraint (mass) is constant when varying the appearance constraint value. As expected, the compliance increases with a tighter appearance constraint value.

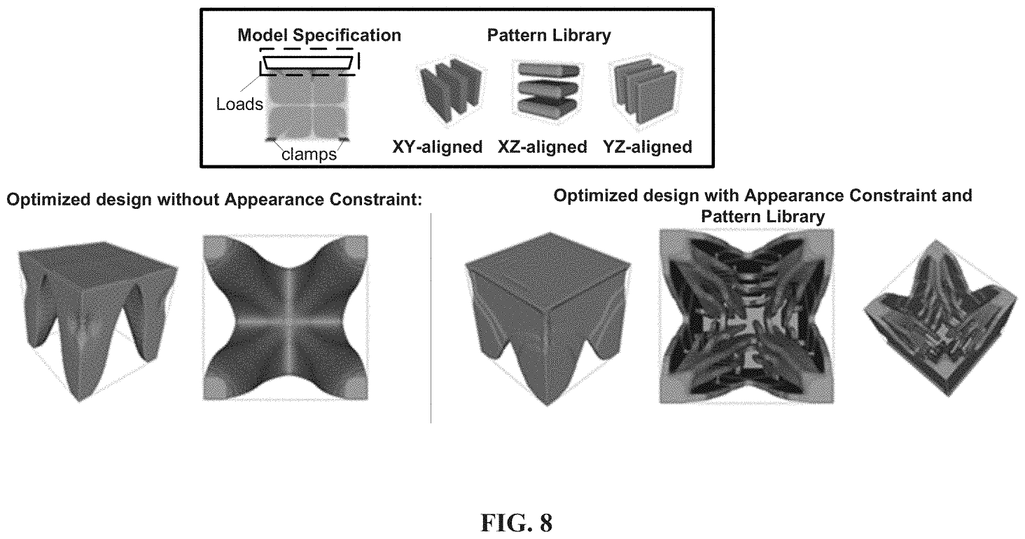

FIG. 8 shows a 3D example optimized design using the previously presented expression Dᵢ. The example shows an application using a library consisting of three discrete oriented membrane geometries for creating an optimized design having connected oriented membrane structures in three planes. Here, an applied discrete pattern library consists of a membrane pattern for each global plane and design obtained from a 3D optimized design without and with an appearance constraint of 0.07.

The approach of the exemplary embodiments described above may be applied to a broader class of problems through various extensions as described further below. The above disclosed embodiments introduce an appearance constraint for a structural optimization problem. The present appearance constraint relies on three main components. The first component is a distance metric between two patches, defined as the sum of squared pairwise differences between the voxels of a 3D model weighted by the value of the center voxel. Alternatively, the weighting may be removed, or a sum of absolute differences may be used to achieve different measurements, among other approaches. Note that in the case of an absolute value function, which is non-differentiable in zero, oscillations may occur during optimization convergence. The second component is the distance value normalization, which is constructed to be patch-dependent. Alternatively, normalization may be performed by the number of voxels in a patch regardless of the current matching. The third component is the aggregation strategy, which is defined as a simple sum but could also be defined as a soft-minimum or soft-maximum function aggregation, thereby, forcing the optimization to achieve a low distance score in only in a single region or for all regions in the design space, respectively.

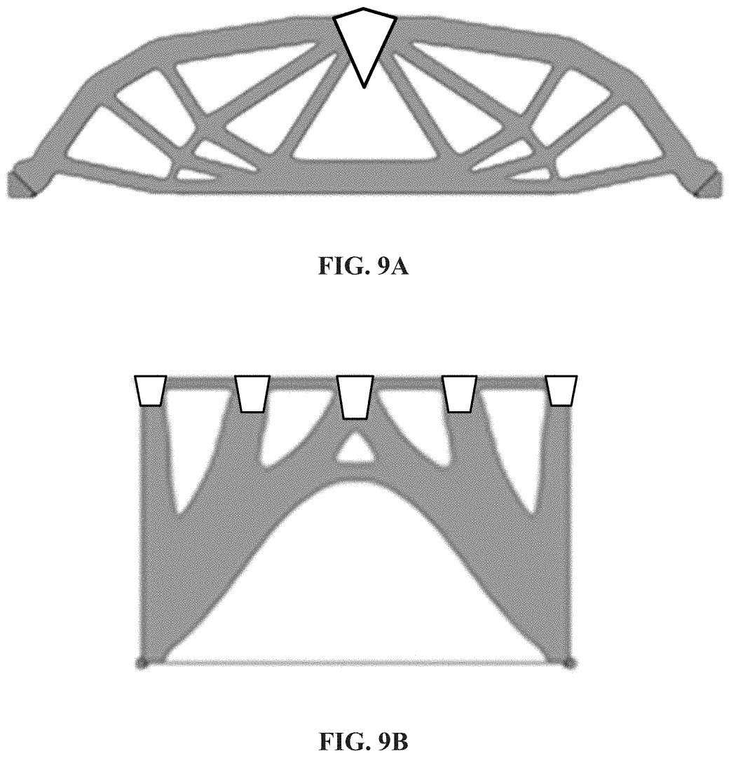

FIGS. 9A-B illustrate this idea by using a combined topology and angle orientation optimization formulation where each element has both a density design variable and a fiber-orientation design variable. Additional information on multiple design variables: may be found, for example, in the article entitled “Structural topology optimization with smoothly varying fiber orientations” (Martin-Pierre Schmidt, Laura Couret, Christian Gout & Claus B. W. Pedersen, published in Structural and Multidisciplinary Optimization, volume 62, pages 3105-3126 (2020)). FIGS. 9A-B highlight a design problem for certain regions that exhibit issues caused by non-convexity of the design problem or field singularities.

When optimizing a structure consisting of an orthotropic constitutive material (transverse isotropic constitutive materials being a subset of orthotropic constitutive material) the orientations of the material are known to have multiple local optima orthogonal to the global optimum yielding a highly non-optimal structural performance. Frequently, this leads to material orientations potentially being “stuck” at 90 degrees to the optimal orientation when using a sensitivity-based optimization. This can be particularly problematic in regions where multiple structural subcomponent members merge at different angles because the material orientation of one member can push the material orientation for another member towards a local optimum.

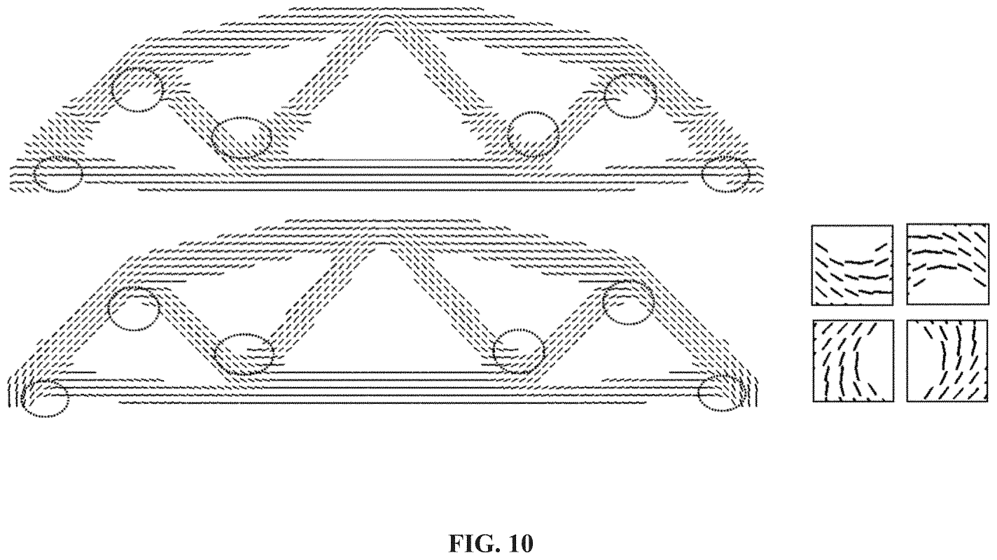

The top drawing of FIG. 10 shows optimized fiber orientations for a beam design exhibiting issues with non-convexity and bottom drawing of FIG. 10 shows an improved beam design where the fiber orientations correctly follow curved paths instead of being stuck in a local minima design having orientation directions orthogonal to the loading directions of the structural members. A small library (shown bottom right) includes examples of preferred material orientation patterns. The optimized beam model shown at the top in FIG. 10 demonstrates this effect at multiple locations marked by circles. Providing a pattern library (bottom right) with examples of preferred material orientations correctly following the curve of geometrical subcomponents can therefore prevent ending up in a local minima. This can then lead to improved designs like the optimized beam model shown at the bottom in FIG. 10. Note the pattern library shown in FIG. 10 (bottom right) contains examples of fiber orientations instead of just density values.

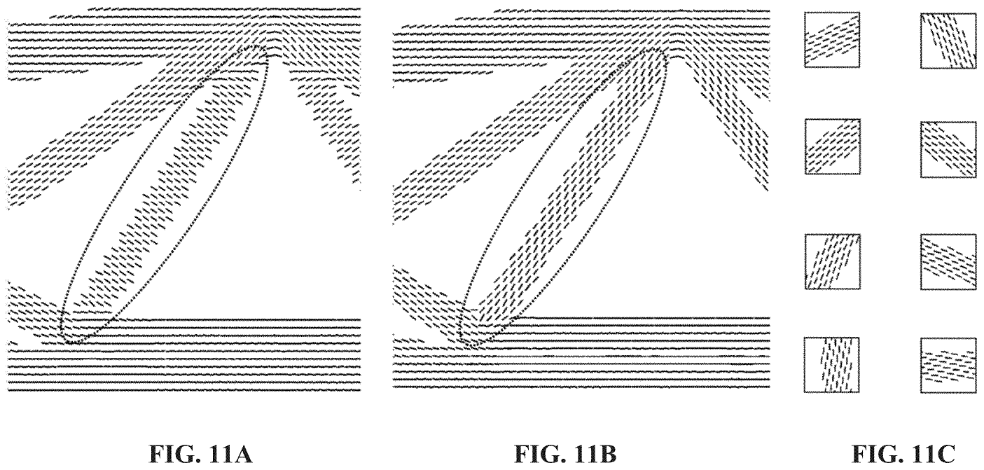

For some extreme cases like the one shown in FIGS. 11A, the non-convexity issue may lead to entire structural members being stuck in a local minimum due to an intricate interaction at element ends towards the material orientations of the other subcomponents or due to unfortunate design variables initialization of the orientations. The approach of the above described embodiment eliminates these two issues by providing a pattern library which guides the optimization toward the desired material configuration. FIG. 11A shows fiber orientations for a subcomponent beam design exhibiting issues with non-convexity, while FIG. 11B shows an improved beam design that can be obtained by guiding the optimization using a pattern library (FIG. 11C) showing preferred fiber orientations relative to the loading directions of the structural subcomponent members.

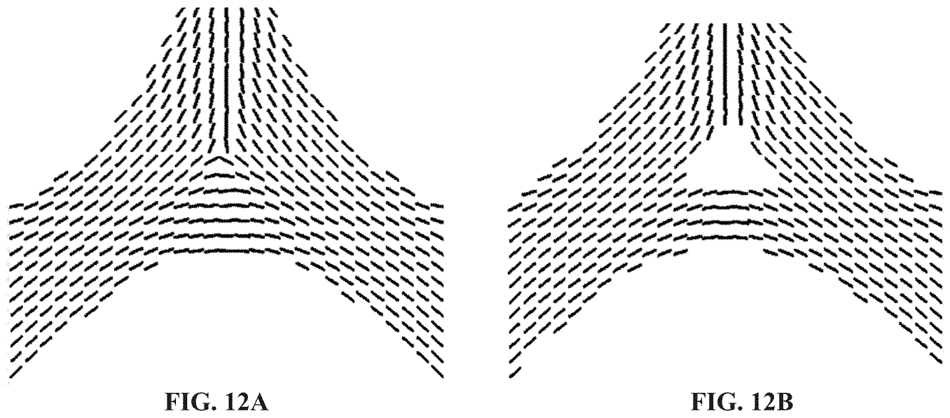

FIGS. 12A-B focus on a small region in the bridge design problem. FIG. 12A shows a common type of point-like singularity for optimized sensitivity-based constitutive material orientations caused by a 3-way crossing of the material orientations (which is different from the previous examples where two subcomponent members are merged together). This form of vector field singularity can be particularly challenging for numerical optimization approaches because the material orientation is mathematically indeterminate in a point. Moreover, it can be proven that varying the neighboring material orientations can never delete this singularity, as the singularity is merely moved to another location. In the solution, the optimization scheme recognizes that the material orientation singularity needs to be erased by changing the relative material densities and thereby, the overall design layout. This type of intricate interplay between different design variable types is challenging to formulate and implement in a numerical optimization scheme. However, by providing an example of valid 3-way crossing in the pattern library, for example, here by splitting into three separate two-way merges, the design optimization is guided toward these valid design configurations.

FIG. 12A is an illustration of an exemplary the fiber orientation in a bridge design exhibiting a vector field singularity in the design variable orientations due to a 3-way attachment point of three subcomponents. FIG. 12B is an illustration of an improvement over the bridge design of FIG. 12A where the vector field singularity in the design variable orientations is resolved by avoiding a 3-way crossing of the material orientations. It should be noted this optimization example is similar to the non-trivial case of the central singularity in a cylinder under torque, which can be removed by hollowing the core of that cylinder.

While the present embodiments are directed to topology optimization as is it a very general and widely used approach for structural optimization problems, the constraint may be applied in a similar fashion to other optimization problems having different types of design variables than the relative material density. For example, another common type of optimization is sizing optimization, in which the design variables are frequently the thickness of shell elements. Introducing the appearance constraint to a sizing optimization problem provides for control of the geometrical layout of the ribs and the panels being determined for the sheet by the sizing optimization. Other examples include bead optimization, where the design variables are the positions of the nodes for a sheet structure. Here the user predefines a library of discrete patterns for manufacturable beads and these patterns can be applied for the bead optimization.

As discussed above, the constraint formulation may be modified to support design variables other than the relative material density. This is achieved by defining a distance metric capable of handling other design variable types. Examples include handling shell element thickness or nodal positions (for the aforementioned sizing and bead Optimization problems, respectively), which is straightforward since those may be handled with simple difference of pairwise real values.

Also as noted previously, another important application includes an industrial scenario for handling a design variable orientation within each voxel of the design space. If the orientation represents a fiber-direction within the material, then the pattern library provides a collection of valid hub connection patterns resolving orientation field singularities. In such applications, the appearance constraint yields consistent structures having better control on fiber orientations and fewer singularities, which is known to be a challenging problem both in the literature and for industrial applications.

Since the appearance constraint only depends on the values of the design variables then it does not have to target a specific physics for the optimization problem. Thereby, the appearance constraint is compatible with physical behaviors other than the structural modeling in the above-described embodiments directed to a compliance minimization objective and mass constraint. As an example, the exact same appearance constraint may be applied to a stress objective minimization problem. In such a scenario, the pattern library provides patterns of rounded corner and smooth geometries, which guide and distribute mechanical stress in a manner not introducing stress singularities. Another example includes the optimization of a heat sink involving the simulation of thermal diffusion through the material and the surfaces. In such a scenario, the discrete pattern library provides various examples of manufacturable heat exchanging fin layouts.

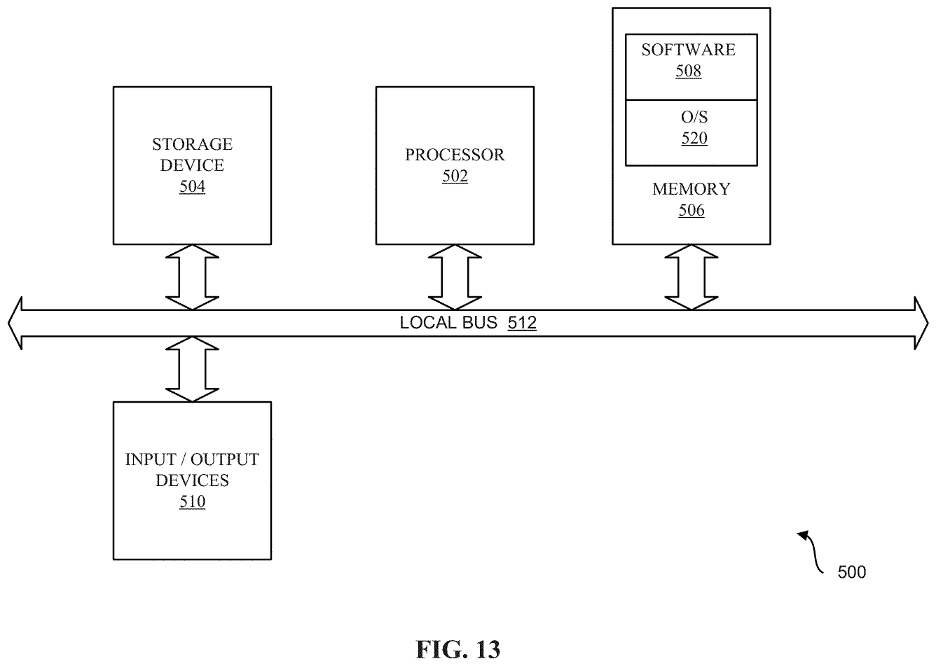

The present system for executing the functionality described in detail above may be a computer, an example of which is shown in the schematic diagram of FIG. 13. The system 500 contains a processor 502, a storage device 504, a memory 506 having software 508 stored therein that defines the abovementioned functionality, input, and output (I/O) devices 510 (or peripherals), and a local bus, or local interface 512 allowing for communication within the system 500. The local interface 512 can be, for example but not limited to, one or more buses or other wired or wireless connections, as is known in the art. The local interface 512 may have additional elements, which are omitted for simplicity, such as controllers, buffers (caches), drivers, repeaters, and receivers, to enable communications. Further, the local interface 512 may include address, control, and/or data connections to enable appropriate communications among the aforementioned components.

The processor 502 is a hardware device for executing software, particularly that stored in the memory 506. The processor 502 can be any custom made or commercially available single core or multi-core processor, a central processing unit (CPU), an auxiliary processor among several processors associated with the present system 500, a semiconductor based microprocessor (in the form of a microchip or chip set), a macroprocessor, or generally any device for executing software instructions.

The memory 506 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 506 may incorporate electronic, magnetic, optical, and/or other types of storage media. Note that the memory 506 can have a distributed architecture, where various components are situated remotely from one another, but can be accessed by the processor 502.

The software 508 defines functionality performed by the system 500, in accordance with the present invention. The software 508 in the memory 506 may include one or more separate programs, each of which contains an ordered listing of executable instructions for implementing logical functions of the system 500, as described below. The memory 506 may contain an operating system (O/S) 520. The operating system essentially controls the execution of programs within the system 500 and provides scheduling, input-output control, file and data management, memory management, and communication control and related services.

The I/O devices 510 may include input devices, for example but not limited to, a keyboard, mouse, scanner, microphone, etc. Furthermore, the I/O devices 510 may also include output devices, for example but not limited to, a printer, display, etc. Finally, the I/O devices 510 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the system 500 is in operation, the processor 502 is configured to execute the software 508 stored within the memory 506, to communicate data to and from the memory 506, and to generally control operations of the system 500 pursuant to the software 508, as explained above.

When the functionality of the system 500 is in operation, the processor 502 is configured to execute the software 508 stored within the memory 506, to communicate data to and from the memory 506, and to generally control operations of the system 500 pursuant to the software 508. The operating system 520 is read by the processor 502, perhaps buffered within the processor 502, and then executed.

When the system 500 is implemented in software 508, it should be noted that instructions for implementing the system 500 can be stored on any computer-readable medium for use by or in connection with any computer-related device, system, or method. Such a computer-readable medium may, in some embodiments, correspond to either or both the memory 506 or the storage device 504. In the context of this document, a computer-readable medium is an electronic, magnetic, optical, or other physical device or means that can contain or store a computer program for use by or in connection with a computer-related device, system, or method. Instructions for implementing the system can be embodied in any computer-readable medium for use by or in connection with the processor or other such instruction execution system, apparatus, or device. Although the processor 502 has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted, or otherwise processed in a suitable manner if necessary, and then stored in a computer memory.

In an alternative embodiment, where the system 500 is implemented in hardware, the system 500 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

As outlined in the background section, the classical topology optimization allows the user very little direct control of the geometrical features. Here, the user defines the design variables for a non-parametric optimization, for example a topology optimization, and further defines an objective function and a constraint or multiple constraint for a structural model or for a Multiphysics model. Additionally, under the exemplary amendments described herein, the user predefines a single pattern or a library of patterns for the optimization, and further defines external parameters for the appearance constraint determining the level of guidance for the optimized design towards the library of patterns and thereby, geometrically guides the layout of the final optimized design.

For example, the previous microstructure and multiscale optimization approaches do not allow geometrical patterning control and do often not achieve a smooth transition between patterns and labels. Likewise, previous approaches do not accommodate multiple patterns, and are limited to relative density variables for topology optimization. Furthermore, such applications typically only handle 2D plate-like designs or assemblies of these 2D plate-like designs for artificially construct a 3D objects, whereas the embodiments directly address a plurality of patterns in 3D. At best, previous approaches might apply an appearance measurement for their single pattern in the objective function whereas the embodiments apply the appearance measurement for the patterns as a constraint. Thereby, previous methods could only optimize appearance as an objective function, which is maybe feasible for strictly aesthetic applications may not be useful for industrial applications requiring optimization of physical performance in an industrial setting. More succinctly the embodiments provide:
improved user control over the geometrical details or patterns that will appear in the final optimized designs;
a user-friendly “guide by example” strategy where the designer can simply provide sections of the desired structural or geometrical features for the optimization; support for multiple pattern samples for a library, which can also be extended by the user when anticipated;
automatic selection of a suitable pattern and sub-region within the selected pattern for each part of the design space;
a geometrical constraint, which can be added to existing structural non-parametric optimization workflows without any dependence on the other targets for the optimization problem or the physics for the optimization problem, e.g., stiffness maximization, peak stress minimization, heat flux exchange maximization, temperature minimization, pressure drop minimization, modal eigenfrequencies maximization, etc.
adaptability to various design variable types (e.g., relative voxel densities, elemental thickness, nodal positions, fiber orientations, material colors, etc.) with minimal software implementation effort and loss in the overall numerical optimization performance, e.g., number of optimization iterations;
convergence to highly detailed designs with patterns from the predefined library in significantly less optimization iterations than any gradient-less approach for a practical or high number of design variables for a user of gradient-based optimization schemes; and
automatic handling of smooth geometrical continuity between regions of the different patterns for the final design, without the pattern library containing patterns that can tile the full design space.

Unlike previous approaches where the design output is constrained by a single input pattern, under the embodiments described above a library of various patterns may be drawn upon to provide for a wider range of appearances. Instead of applying an appearance control as an objective function for the optimization, the above-described embodiments use an appearance control as constraint for the optimization, providing a user controllable constraint to set external parameters for the optimization to determine if a pattern from the library is loosely or tightly followed in the final optimized design. Furthermore, using different constraint values for the appearance constraint also allows a user to study the impact of the pattern library on the guided design compared the objective function and various other constraints. This also provides for 3D applications valuable for industrial applications.

In contrast with multi-scale techniques, the above embodiments map and guide the geometrical properties to a discrete geometrical pattern library and therefore, can consider a mixture of mechanical properties and geometrical properties. Additionally, multi-scale approaches do often not achieve a smooth transition between patterns or additional restrictions are applied for ensuring a smooth transition.

In comparison with design variable parametrization using filter techniques and projection methods of the design variables, the exemplary embodiment does not include applying a new parametrization of the design variables or mapping of the design variables, but instead has a guiding library containing several different geometrical layouts. Note, the structural layouts in the guided library can also be chosen with respect to manufacturability so these prechosen structural layouts in the library are chosen with one or more specific manufacturing processes in mind.

The exemplary embodiments are described above with regard to an improvement upon the classic topology optimization where the design variables are typically relative material densities. However, the embodiments are not limited to relative density design variables but are also applicable for other non-parametric design variables, for example, sizing thickness, sizing radius, sizing angles, among others.

Topology optimization and non-parametric optimization illustrated in the above embodiments may be applied to Multiphysics systems and not only structural systems for example: thermal, electromagnetic and CFD (computational fluid dynamics). The approach described above may be applied to both structural systems and Multiphysics systems, as the optimization can be applied for many different objective functions and constraints. The approach described herein may be combined with the different objective functions and constraints of both structural and Multiphysics systems.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A computer based method for design optimization of a finite element model in a computer aided design (CAD) environment guided by a discrete geometrical pattern library, comprising the steps of:
applying a boundary condition to the finite element model;
initializing design variables for the bounded finite element model;
evaluating an objective function for the finite element model;
evaluating a gradient of the objective function with respect to the design variables;
evaluating an appearance constraint function for the finite element model;
evaluating a gradient of the appearance constraint function with respect to the design variables;
updating the design variables using a mathematical programming;
detecting a convergence in the design optimization; and
producing a converged design optimization of the finite element model.

2. The method of claim 1, further comprising the step of setting up a discrete pattern library.

3. The method of claim 2, further comprising the steps of:
determining pattern locations for a design variable applied for calculating an appearance constraint and its gradients; and
computing an appearance constraint function.

4. The method of claim 3, wherein determining pattern locations further comprises the steps of:
searching for an improved local match with respect to the other discrete patterns of the pattern library;
probing local matches using a predefined search area of a current assign pattern from searching for improved local matches; and
probing improved local matches by propagating matches of a local neighborhood pattern from probing local matches.

5. The method of claim 1, further comprising the steps of:
evaluating a secondary constraint for the finite element model;
evaluating the secondary constraint with respect to the design variables; and
evaluating a secondary objective.

6. The method of claim 5, wherein the secondary constraint is one of the group consisting of a stress constraint, a modal eigenfrequency as an objective to maximized, a displacement constraint, and a force constraint.

7. The method of claim 5, wherein the secondary constraint is one of the group consisting of thermal flux, temperature, mass, a local volume fraction, overhang, and perimeter length.

8. The method of claim 5, wherein the secondary constraint comprises a structural or Multiphysics constraint.

9. The method of claim 1, further comprising the step of enhancing physical properties for other design responses (DRESPs) applied in the optimization setup.

10. The method of claim 1, further comprising the steps of:
receiving a total allowable appearance fraction parameter value; and
adjusting the resemblance of the finite element model to the pattern library according to the allowable appearance fraction parameter.

11. The method of claim 10, wherein the total allowable appearance fraction parameter value is in the range [0;1].

12. The method of claim 1, wherein applying boundary conditions to the bounded finite element model further comprises the step of:
creating a discretizing of a design space of the finite element model.

13. The method of claim 12, wherein creating a discretizing of the design space further comprises the steps of:
subdividing the space into a plurality of simple connected elements, wherein the plurality of simple connected element serve as a finite element mesh for a simulation of the model and/or for containing the design variables for the optimization; and
determining an applied force and a clamped boundary condition to nodes of the finite element mesh.

14. The method of claim 1, wherein the mathematical programming comprises a gradient-based mathematical programming configured to modify a relative density of an element of the finite element model without violating a specified constraint and optimize the objective function.
